(19) United States
(12) Patent Application Publication
(10) Pub. No.: US 2010/0136999 A1
(43) Pub. Date: Jun. 3, 2010

(54) APPARATUS AND METHOD FOR DETERMINING POSITION OF TERMINAL

(75) Inventors: Byung Doo KIM, Daejeon (KR); Youngsu CHO, Seoul (KR); Seong Yun CHO, Daejeon (KR); Sung Jo YUN, Daejeon (KR); Sun-Joong KIM, Daejeon (KR); Wan Sik CHOI, Daejeon (KR); Jong-Hyun PARK, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/551,963

(22) Filed: Sep. 1, 2009

(30) Foreign Application Priority Data
Dec. 3, 2008 (KR) 10-2008-0122002
Mar. 31, 2009 (KR) 10-2009-0027796

(51) Int. Cl. H04W 24/00

(52) U.S. Cl. 455/456.1

(57) ABSTRACT

An apparatus for determining a position of a terminal calculates distances between a terminal and a plurality of base stations by using time information acquired by a reference station among the plurality of base stations through unidirectional communication between the terminal and the base stations and between the base stations, and determines a position of the terminal by using the calculated distances.

### CROSS-REFERENCE TO RELATED APPLICATION

This application claims priority to and the benefit of Korean Patent Application Nos. 10-2008-0122002 and 10-2009-0027796 filed in the Korean Intellectual Property Office on Dec. 3, 2008 and Mar. 31, 2009, the entire contents of which are incorporated herein by reference.

### BACKGROUND OF THE INVENTION

(a) Field of the Invention

The present invention relates to an apparatus and method for determining a position of a terminal.

(b) Description of the Related Art

Recently, as the necessity of position information of a terminal in a limited space such as a wireless sensor network or an indoor environment has greatly increased, methods for providing position information of the terminal through various means such as a wireless local area network (LAN), an ultra wide band (UWB), and a Zigbee have been increasingly studied.

Various methods exemplarily including time of arrival (TOA), time difference of arrival (TDOA), angle of arrival (AOA), and received signal strength (RSS) for determining a position of a terminal with a wireless network have been researched. Among the various methods, a method that uses a time measurement value such as the TOA or the TDOA can provide relatively more accurate position information than other methods using other measurement values. A method for determining a position of a terminal using the TOA or the TDOA uses a synchronized network or a two-way ranging (TWR) method. However, the TWR method must perform communication two or more times for acquiring a distance measurement value, and therefore it is difficult to quickly provide position information of a terminal due to a network communication load.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and method for determining a position of a terminal for quickly providing position information of the terminal while reducing a network communication load, and a method thereof.

According to an exemplary embodiment of the present invention, a method for determining a position of a terminal is provided. The method according to the exemplary embodiment of the present invention includes calculating distances between the terminal and a plurality of base stations by using time information acquired by a reference station among the plurality of base stations through unidirectional communication between the terminal and the plurality of base stations and between the plurality of base stations and determining a position of the terminal by using the distances between the terminal and the plurality of base stations.

According to another exemplary embodiment of the present invention, an apparatus for determining a position of a terminal is provided. The apparatus according to the other exemplary embodiment of the present invention includes a distance calculating unit and a position determining unit. The distance calculating unit calculates distances between the terminal and a plurality of base stations by using a plurality of first receiving time information data, a plurality of transmitting time information data, and a plurality of second receiving time information data. The plurality of first receiving time information data correspond to times at which the plurality of base stations respectively receive a signal transmitted from the terminal, the plurality of transmitting time information data correspond to times at which base stations, excluding a reference base station, among the plurality of base stations, respectively transmit the received first receiving time information data to the terminal, and the plurality of second receiving time information data correspond to times at which the reference station receives the first receiving times of the base stations, excluding the reference base station, among the plurality of base stations

The position determining unit determines a position of the terminal by using the distances between the terminal and the plurality of base stations.

A method for determining a position of a terminal according to another exemplary embodiment of the present invention includes receiving a plurality of receiving time information data corresponding to times at which a plurality of base stations respectively receive a signal transmitted from the terminal, receiving a plurality of transmitting time information data corresponding to times at which a plurality of first base stations, excluding a reference station, among the plurality of base stations respectively transmit the corresponding first receiving time information data to the reference station, receiving a plurality of second receiving time information data corresponding to times at which the reference station receives transmitting time information data of each of the plurality of first base stations, calculating distances between the terminal and the plurality of base stations by using the plurality of first receiving time information data, the plurality of transmitting time information data, and the plurality of second receiving time information data, and determining a position of the terminal by using the distances between the terminal and the plurality of base stations.

According to the exemplary embodiments of the present invention, distances between a terminal, a reference station, and base stations are measured through unidirectional communication so that a network communication load can be reduced and position information of the terminal can be quickly provided.

### BRIEF DESCRIPTION OF THE DRAWINGS

FIG. 1 shows an asynchronous wireless network system applied to the present invention.

FIG. 2 is a schematic timing diagram of unidirectional communication according to an exemplary embodiment of the present invention.

FIG. 3 shows a position determining server according to an exemplary embodiment of the present invention.

FIG. 4 is a flowchart of a method for determining a position of a terminal according to an exemplary embodiment of the present invention.

FIG. 5 shows a transmission time according to a geometric distance between base stations of FIG. 1.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation, and can be implemented by hardware components or software components and combinations thereof.

In the specification, a mobile terminal (MT) may indicate a terminal, a mobile terminal (MT), a mobile station (MS), a subscriber station (SS), a portable subscriber station (PSS), user equipment (UE), and an access terminal (AT), and may include entire or partial functions of the terminal, MT, SS, PSS, UE, and AT.

A base station (BS) may indicate an access point (AP), a radio access station (RAS), a nodeB (Node B), an evolved node-B (eNB), a base transceiver station (BTS), and a mobile multihop relay (MMR)-BS, and may include entire or partial functions of the AP, RAS, nodeB, eNB, BTS, and MMR-BS.

Hereinafter, an apparatus and method for determining a position of a terminal according to an exemplary embodiment of the present invention will be described in further detail with reference to the drawings.

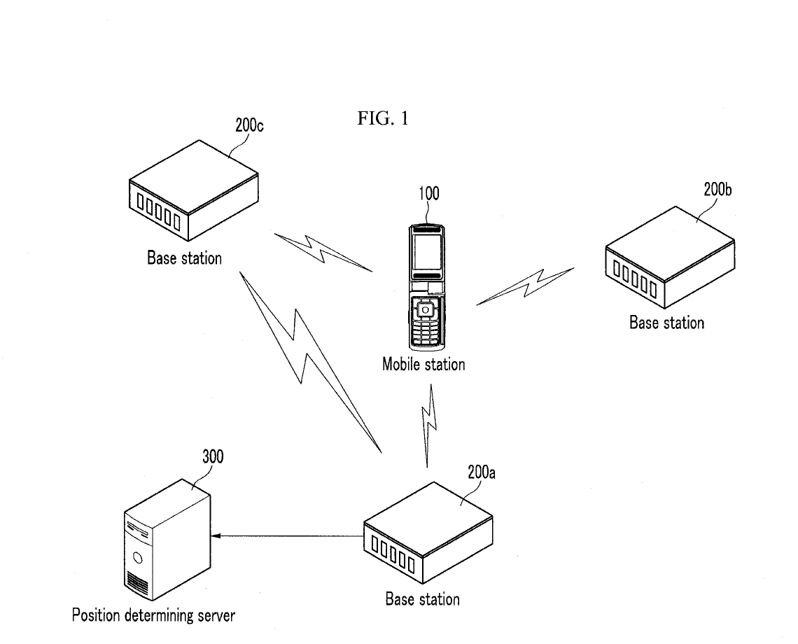

FIG. 1 shows an asynchronous wireless network system applied to the present invention.

Referring to FIG. 1, an asynchronous wireless network system includes a mobile terminal (MT) 100 that transmits a position request signal, a plurality of base stations 200a, 200b, and 200c, and a position determining server 300.

Each of the plurality of base stations 200a, 200b, and 200c records a receiving time of a signal transmitted from the MT 100.

In addition, two of the plurality of base stations 200a, 200b, and 200c, for example, the base stations 200b and 200c, respectively receive the signal transmitted from the MT 100 and transmit receiving time information of the signal transmitted from the MT 100 by using wireless data communication to the base station 200a after a predetermined time delay. In this case, the two base stations 200b and 200c transmit a transmission time of the receiving time of the signal transmitted from the MT 100, that is, transmission time information, to the base station 200a, together with the receiving time information through wireless data communication. Then, the base station 200a transmits receiving time information of signals of the two base station 200b and 200c, the receiving time information of the signal transmitted from the MT 100, and the transmitting time information of the two base stations 200b and 200c to the position determining server 300. Hereinafter, the base station 200a that finally transmits time information to the position determining server 300 is referred to as a reference station 200a in order to distinguish with the two base stations 200b and 200c.

The position determining server 300 determines a position of the MT by using the time information finally received from the reference station 200a. That is, the position determining server 300 can determine a position of the MT 100 by using time information acquired not through bidirectional communication but through unidirectional communication in the asynchronous wireless network.

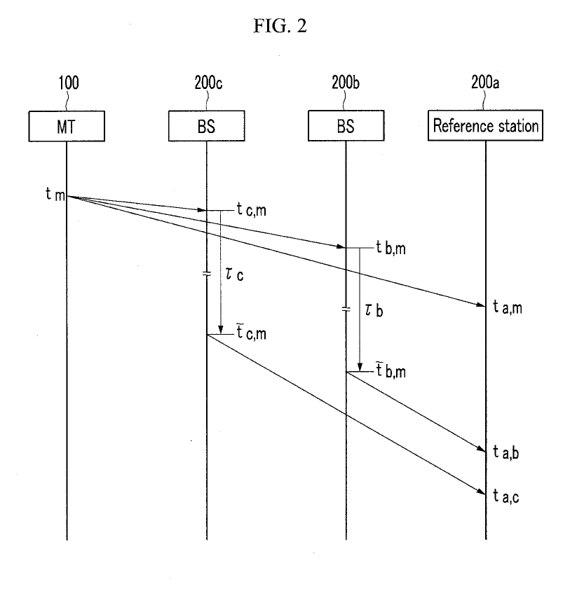

FIG. 2 is a schematic timing diagram of unidirectional communication according to the exemplary embodiment of the present invention.

Referring to FIG. 2, when the MT 100 transmits a position request signal at time tₘ, the reference station 200a and the base stations 200b and 200c respectively receive the signal of the MT 100 at times t_{a,m}, t_{b,m}, and t_{c,m} according to a distance between the MT 100 and the reference station 200a and a distance between the MT 100 and the base stations 200b and 200c. Then, the reference station 200a and the base stations 200b and 200c respectively record the receiving times t_{a,m}, t_{b,m}, and t_{c,m}.

The base stations 200b and 200c respectively transmits receiving time information t_{b,m}, t_{o,m} to the reference station 200a through the wireless data communication after predetermined times τ_{b} and τ_{c}. In this case, transmitting time information \tilde{t}_{b,m} and \tilde{t}_{c,m} are transmitted together with the receiving time information.

The reference station 200a receives the signals from the base stations 200b and 200c at times t_{a,b} and t_{a,c} after a delay according to the distance between the reference station 200a and the base stations 200b and 200c.

Then, the reference station 200a transmits the receiving time information t_{a,m} and the time information t_{b,m}, t_{c,m}, \tilde{t}_{b,m}, and \tilde{t}_{c,m} respectively received from the base stations 200b and 200c to the position determining server 300.

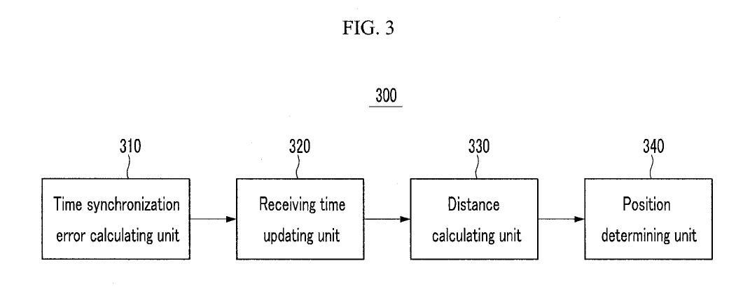

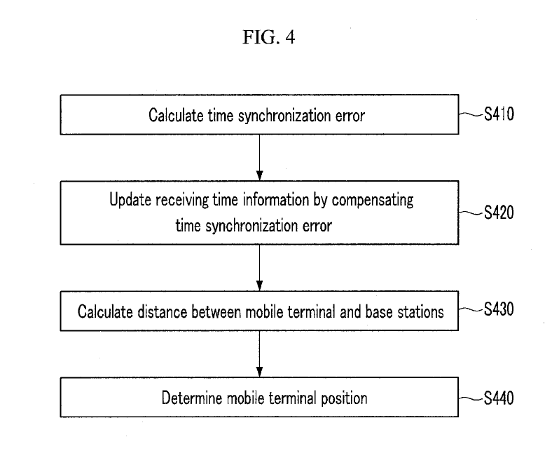

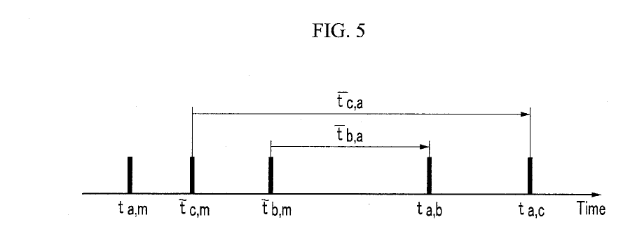

FIG. 3 shows the position determining server according to the exemplary embodiment of the present invention, and FIG. 4 is a flowchart of a method for determining a position of a terminal according to an exemplary embodiment of the present invention. FIG. 5 shows a transmitting time according to a geometrical distance between the base stations of FIG. 1.

Referring to FIG. 3, the position determining server 300 includes a time synchronization error calculator 310, a receiving time updating unit 320, a distance calculating unit 330, and a position determining unit 340.

Referring to FIG. 4, the time synchronization error calculator 310 calculates time synchronization errors Δt_{a,b} and Δt_{a,c} between the reference station 200a and the two base stations 200b and 200c (S410). The time synchronization errors Δt_{a,b} and Δt_{a,c} may be respectively calculated as given in Equation 1 and Equation 2.

Δt_{a,b}=t_{a,b}−\tilde{t}_{b,m}− t̅_{b,a} [Equation 1]

Δt_{a,c}=t_{a,c}−\tilde{t}_{c,m}− t̅_{c,a} [Equation 2]

Here, t̅_{b,a} and t̅_{c,a} denote transmission times according to the geometrical distances between the reference station 200a and the base station 200b and between the reference station 200a and the base station 200c, and may be represented as shown in FIG. 5. t̅_{b,a} and t̅_{c,a} may be respectively calculated from positions of the reference station 200a and the base stations 200b and 200c as given in Equation 3 and Equation 4.

$$\begin{matrix}{\overline{t}}_{b , a} = \frac{\sqrt{{( {x}_{b} - {x}_{a} )}^{2} + {( {y}_{b} - {y}_{a} )}^{2} + {( {z}_{b} - {z}_{a} )}^{2}}}{d} & [ Equation 3 ] \\ {\overline{t}}_{c , a} = \frac{\sqrt{{( {x}_{c} - {x}_{a} )}^{2} + {( {y}_{c} - {y}_{a} )}^{2} + {( {z}_{c} - {z}_{a} )}^{2}}}{d} & [ Equation 4 ]\end{matrix}$$

Here, xₐ, yₐ, and zₐ denote a position of the reference station 200a, x_{b}, y_{b}, and z_{b} denote a position of the base station 200b, and x_{c}, y_{c}, and z_{c} denote a position of the base station 200c. d denotes the speed of light.

The receiving time updating unit 320 compensates the time synchronization errors Δt_{a,b} and Δt_{a,c} at the receiving time information t_{b,m} and t_{c,m} to update receiving time of the base stations 200b and 200c (S420). Updated receiving times \tilde{t}_{b,m} and \tilde{t}_{c,m} of the base stations 200b and 200c may be obtained as given in Equation 5 and Equation 6.

\hat{t}_{b,m}=t_{b,m}Δt_{a,b} [Equation 5]

\hat{t}_{c,m}=t_{c,m}+Δt_{a,c} [Equation 6)

The distance calculating unit 330 calculates distances rₐ, r_{b}, and r_{c} between the MT 100 and the reference station 200a and the base station 200b and 200c by using the receiving time information t_{a,m}, \tilde{t}_{b,m}, and \tilde{t}_{c,m} (S430). The distances rₐ, r_{b}, and r_{c} between the MT 100 and the reference station 200a and the base stations 200b and 200c may be calculated as given in Equation 7 to Equation 9.

rₐ=d·t_{a,m} [Equation 7]

r_{b}=d·\hat{t}_{b,m} [Equation 8]

r_{c}=d·\hat{t}_{c,m} [Equation 9]

The position determining unit 340 determines a position of the MT 100 by using the distances rₐ, r_{b}, and r_{c} between the MT 100 and the reference station 200a and base stations 200b and 200c (S440).

The distance calculating unit 330 may calculate distances r_{b,a} and r_{c,a} between the reference station 200a and the base stations 200b and 200c by using the distances rₐ, r_{b}, and r_{c} between the MT 100 and the reference station 200a and base stations 200b and 200c. The distances r_{b,a} and r_{c,a} between the reference station 200a and the base stations 200b and 200c may be calculated as given in Equation 10 and Equation 11.

r_{b,a}=r_{b}−rₐ [Equation 10]

r_{c,a}=r_{c}−rₐ [Equation 11]

In addition, the position determining unit 340 may determine the position of the MT 100 by using the distances r_{b,a} and r_{c,a} between the reference station 200a and the base stations 200b and 200c.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for determining a position of a terminal, comprising:
calculating distances between the terminal and a plurality of base stations by using time information acquired by a reference station among the plurality of base stations through unidirectional communication between the terminal and the plurality of base stations and between the plurality of base stations; and
determining a position of the terminal by using the distances between the terminal and the plurality of base stations.

2. The method of claim 1, wherein the determining comprises:
calculating distances between the plurality of base stations by using the distances between the terminal and the plurality of base stations; and
determining the position of the terminal by using the distance between the plurality of base station.

3. The method of claim 1, wherein the time information acquired by the reference station comprises:
a plurality of first receiving time information data that respectively correspond to receiving times at which the plurality of base stations receive a signal transmitted from the terminal;
a plurality of transmitting time information data that respectively correspond to times at which a plurality of first base stations among the plurality of base stations, excluding the reference station, transmit the first receiving time information of the plurality of first base stations to the reference station; and
a plurality of second receiving time information data that correspond to times that the reference station receive the first receiving time information of the plurality of first base stations.

4. The method of claim 3, wherein the plurality of transmitting time information data are transmitted to the reference station when the plurality of first base stations transmit the first receiving time information thereof.

5. The method of claim 1, wherein the calculating comprises:
calculating time synchronization errors between the reference station and the plurality of first base stations by using the plurality of second receiving time information data and the plurality of transmitting time information data;
updating the first receiving time information of the plurality of first base stations by compensating the time synchronization errors between the reference station and the plurality of first base stations; and
calculating distances between the terminal and the plurality of base stations respectively by using the updated first receiving time information of the plurality of first base stations and the first receiving time information of the reference station.

6. An apparatus for determining a position of a terminal, comprising:
a distance calculating unit for calculating distances between the terminal and a plurality of base stations by using a plurality of first receiving time information data, a plurality of transmitting time information data, and a plurality of second receiving time information data, the plurality of first receiving time information data corresponding to times at which the plurality of base stations respectively receive a signal transmitted from the terminal, the plurality of transmitting time information data corresponding to times at which base stations, excluding a reference base station, among the plurality of base stations respectively transmit the received first receiving time information data to the terminal, and the plurality of second receiving time information data corresponding to times at which the reference station receives the first receiving times of the base stations; and
a position determining unit for determining a position of the terminal by using the distances between the terminal and the plurality of base stations.

7. The apparatus of claim 6, further comprising:
a time synchronization error calculator that calculates time synchronization errors between the reference station and the base stations by using the plurality of second receiving time information data and the plurality of transmitting time information data; and
a receiving time updating unit that updates the first receiving time information of the base stations by applying the time synchronization errors between the reference station and the base stations to the first receiving time information of the base stations,
wherein the distance calculating unit respectively calculates distances between the terminal and the plurality of base stations by using updated first receiving time information of the base stations and first receiving time information of the reference station.

8. The apparatus of claim 6, wherein the distance calculating unit calculates distances between base stations by using the distances between the terminal and the plurality of base stations, and the position determining unit determines a position of the terminal by using the distances between the base stations.

9. A method for determining a position of a terminal, comprising:
receiving a plurality of receiving time information data corresponding to times at which a plurality of base stations respectively receive a signal transmitted from the terminal;
receiving a plurality of transmitting time information data corresponding to times at which a plurality of first base stations, excluding a reference station, among the plurality of base stations respectively transmit the corresponding first receiving time information to the reference station;
receiving a plurality of second receiving time information data corresponding to times at which the reference station receives transmitting time information of each of the plurality of first base stations;
calculating distances between the terminal and the plurality of base stations by using the plurality of first receiving time information data, the plurality of transmitting time information data, and the plurality of second receiving time information data; and
determining a position of the terminal by using the distances between the terminal and the plurality of base stations.

10. The method of claim 9, wherein the plurality of first receiving time information data, the plurality of transmitting time information data, and the plurality of second receiving time information data are received through the reference station, and when first receiving time information data of the plurality of first base stations that are transmitted to the reference station, the plurality of first base stations transmit the plurality of transmitting time information data to the reference station, together with the first receiving time information.

11. The method of claim 9, wherein the determining of the position comprises:
calculating distances between base stations by using the distances between the terminal and the plurality of base stations; and
determining the position of the terminal by using the distances between the base stations.

12. The method of claim 9, wherein the calculating of the distances comprises:
calculating time synchronization errors between the reference station and the plurality of first base stations by using the plurality of second receiving time information data and the plurality of transmitting time information data;
updating the first receiving time information of the plurality of first base stations by compensating the time synchronization errors between the reference station and the plurality of first base stations in the first receiving time information of the first base stations; and
respectively calculating the distances between the terminal and the plurality of base stations by using the updated first receiving time information of the plurality of first base stations and the reference station.
